(19) United States
(12) Patent Application Publication
(10) Pub. No.: US 2010/0271206 A1
(43) Pub. Date: Oct. 28, 2010

(54) THEFT PREVENTION SYSTEM FOR A PORTABLE ELECTRIC APPARATUS

(76) Inventor: Wessel Blankestijn, Wormerveer (NL)

Correspondence Address: LAW OFFICES OF ERIC KARICH, 2807 ST. MARK DR., MANSFIELD, TX, 76063, US

(21) Appl. No.: 12/600,417

(22) PCT Filed: May 16, 2008
(86) PCT No.: PCT/NL2008/050290

§ 371 Date: Jul. 7, 2010

(30) Foreign Application Priority Data
May 16, 2007 (NL) 2000650

(51) Int. Cl. G08B 13/14

(52) U.S. Cl. 340/568.1

(57) ABSTRACT

A theft protection system for an electrical appliance is connected between an electrical appliance, such as a laptop computer, and a voltage source. The theft protection system regularly measures the charging current that is carried between the electrical appliance and the voltage source. If this charging current drops below a predetermined minimum value, a limit value, the theft protection system delivers an alarm signal via an alarm means. The limit value can be set by means of an incorporated calibration unit. The calibration is initiated by pressing the set button.

### FIELD OF THE INVENTION

The invention relates to a theft protection system for use with a portable electrical appliance which is connectable to a voltage source via an adapter with transformer, in which in connected mode a charging current is carried between the voltage source and the portable electrical appliance, which theft protection system comprises an electronic alarm circuit to be inserted between the adapter and the voltage source, the alarm circuit comprising a processing unit with a current detector as well as an alarm means that delivers an alarm signal when the current detector detects a drop of the charging current below a predetermined limit value. A portable electrical appliance is understood to be an electrical appliance which is by nature of its function intended to be regularly moved to another location of use and which is of a suitably light design with the object of rendering this appliance easily manually movable for a user.

### STATE OF THE ART

A theft protection system of this type is known from WO 95/27958A. This known theft protection system is suitable for protecting electrical appliances in which the transformer is incorporated. For in this known system the complete absence of a current is detected, which occurs if the transformer is disconnected from the power source. In modern society people are ever more mobile and, in consequence, portable personal appliances are very much in demand. They include portable electrical appliances such as mobile telephones and laptop computers. Electrical appliances of this type include an incorporated power source such as an accumulator or battery to enable their use without being connected to the mains. This provides extra mobility for the user. The user can utilize the appliance at substantially any location thanks to the incorporated power source. An accumulator is to be charged at regular intervals from the mains by means of a transformer which is generally incorporated in a specially arranged adapter. The appliance can also be used while being connected to the mains via the adapter. More particularly laptop computers are generally used in this fashion. The accumulator of such an appliance is suitable for a continuous charging program. The average user uses a laptop computer at home or at work in the same manner as a desktop computer is used, the laptop computer always being connected to the mains via an adapter and being moved only little. The user does not always take the appliance with him or her and often leaves it abandoned for a rather long period of time. A disadvantage of the laptop computer is in this context the mere fact that it is portable. Any thief can easily disconnect the appliance and take it with him. In many cases a steel cable is used as a protection of portable electrical appliances such as laptop computers, which cable can on the one hand be clicked to the appliance and on the other to for example a leg of the table. A drawback of this solution is that such a cable can easily be disengaged from the appliance. In addition, a thief can do this unnoticed. Therefore, with the existing protection measures, portable appliances such as laptop computers continue to be liable to theft.

### SUMMARY OF THE INVENTION

It is an object of the invention to provide a theft protection system for use with a portable electrical appliance which cannot be inactivated unnoticed and in a simple manner prior to protective measures being taken. For this purpose, the theft protection system according to the invention is characterized in that the charging current, in a situation in which only the adapter with transformer is connected, forms a measure for the limit value. If the electrical appliance is disconnected from the adapter, whereas the adapter continues to be connected to the power source via the theft protection system, the flowing charging current will become lower and drop below the limit value. The theft protection system will detect this change and then deliver an alarm signal with the alarm means. The moment a thief disconnects the chain at any spot, an alarm signal will be delivered. Therefore, a thief cannot inactivate the theft protection system unnoticed or in an easy manner prior to protective measures being taken. Always an alarm signal will be delivered by which an owner or guard can be warned.

An embodiment of the theft protection system according to the invention is characterized in that the alarm circuit comprises a calibration unit with which a basic charging current can be determined which is a measure for the limit value, which basic charging current occurs in the situation in which only the adpater with transformer is connected and the electrical appliance is not connected. As a result of this measure the situation of absence of the electrical appliance can be established in a more accurate manner. For in the event of absence of the electrical appliance the charging current is not always equal to zero. If the adapter is left behind, there is still an electronic circuit that may require some current. In this situation too the alarm means would have to deliver an alarm signal. Since different charging currents are carried in different electrical appliances and adapters, it is desirable to be in a position to determine the limit value for each application, so that one can also be sure that the alarm goes off when the electrical appliance is disconnected.

The invention also relates to a method for detecting theft of an electrical appliance by means of the theft protection system according to the invention in which a basic charging current is determined by means of a calibration unit, which basic charging current corresponds with the situation in which only the adapter with transformer is connected, the magnitude of the basic charging current being a measure for the limit value.

An embodiment of the method according to the invention is characterized in that the charging current is measured for at least 1 second so as to determine an average charging current. In this way any disturbances at the voltage source are averaged, so that the alarm means will deliver an alarm signal only if the electrical appliance is disconnected and not in case of a disturbance at the voltage source, such as a voltage peak or voltage dip as a consequence of another piece of equipment utilizing the same source and being switched on or off.

A further embodiment of the method according to the invention is characterized in that the voltage source is an AC voltage source and a zero crossing at the voltage source is determined and in that the charging current is measured from a fixed instant after the zero crossing. In most cases the electrical appliance will be intended to be connected to an AC voltage, generally the mains. In the event of a connection to the mains, the accumulator of the appliance will be charged if the AC voltage is around its peak value. So there is mention of a strongly varying periodical charging current. If the measurement of the charging current is started at a fixed point of time after the zero crossing of the AC voltage, there will always be a fixed number of charging current peaks during the time of measurement. It will then not be possible for the measuring operation to be ‘fouled’ as a result of a varying number of peaks being measured. Therefore, also a shorter measuring period than with a varying number of peaks will suffice.

A still further embodiment of the method according to the invention is characterized in that the alarm signal is delivered after the current detector in at least two consecutive measurements detects a drop of the charging current below the limit value. In this way additional protection is exercised and the probability is reduced of the alarm means delivering an alarm signal when it detects a chance major disturbance at the voltage source.

### BRIEF DESCRIPTION OF THE DRAWINGS

The invention will be described in more detail based on examples of embodiment of the theft protection system according to the invention while reference is made to the appended drawing figures, in which:

FIG. 1 gives a diagrammatic representation of the theft protection system according to the invention;

FIG. 2 gives a diagrammatic representation of the electrical appliance that is connected to a theft protection system according to the invention; and

FIG. 3 gives a representation over time of the voltage of the AC voltage source and the charging current of the electrical appliance.

### DETAILED DESCRIPTION OF THE DRAWINGS

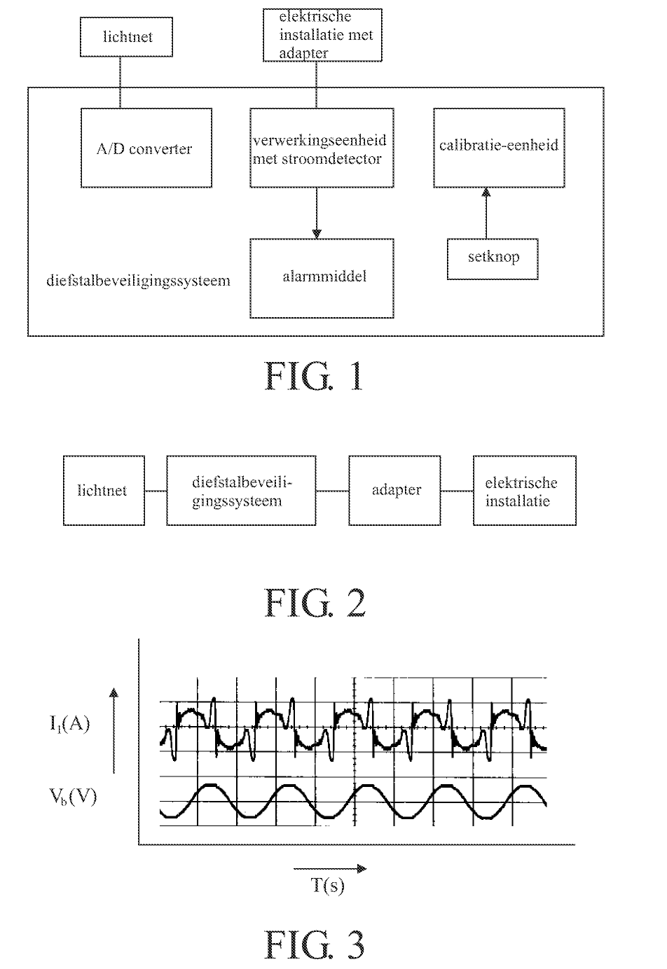

FIG. 1 gives a diagrammatic representation of an embodiment of the theft protection system according to the invention. The theft protection system includes an A/D converter which converts voltage from an AC voltage source, in this case the mains, into a DC voltage which can be used for the measuring electronics in the processing unit. An alarm means is connected to the processing unit. If the processing unit detects an unauthorized change of the charging current, that is to say, a drop below the limit value, a signal is applied to the alarm means which thereupon releases an alarm signal. The calibration unit can be utilized for setting the limit value. The set button can initiate a calibration operation. The calibration is carried out by inserting the theft protection system between the voltage source and the loose adapter and pressing the set button. The processing unit thereupon measures the bare charging current that flows when only the adapter is present. Then the value of the limit value (minimum charging current) is set in the processing unit. This limit value is equal to the bare charging current increased by a suitable percentage. This suitable percentage is selected such that the charging current in the presence of the electrical appliance is nearly always higher than the limit value. If the charging current drops below the limit value during the use of the theft protection system, this will be an indication that the electrical appliance is no longer connected. If this is the case, the alarm means will deliver an alarm signal. If only the electrical appliance is disconnected and the adapter continues to be connected, the charging current also has a value that is below the limit value since, as described above, this limit value is equal to the charging current of the adapter increased by a suitable percentage.

FIG. 2 gives a diagrammatic representation of an electrical appliance connected to a theft protection system according to the invention. The theft protection system is connected between the voltage source (in this case the mains) and the adapter of the electrical appliance. During operation the theft protection system utilizes the mains voltage for its operation. However, as a back-up also an accumulator is incorporated in the theft protection system. If the theft protection system is disconnected from the voltage source, the charging current will drop far below the minimum charging current and the alarm means will deliver an alarm signal for which it utilizes its energy from the incorporated accumulator.

FIG. 3 is a representation over time of the voltage of the AC voltage source and the charging current of the electrical appliance. The lower graph shows the variation over time of the AC voltage of the AC voltage source (V_{b}). The upper graph shows the charging current as a function of time. It can be noticed that the charging current has a peak at the maximums and minimums of the AC voltage. As appropriate, cases do even occur where there is a charging operation only in the neighborhood of the voltage maximums and voltage minimums and not any further. The charging current peaks form a great contribution to the average charging current. Therefore, it is of importance to provide that during the measuring time always an equal number of peaks are measured. In this way the average charging current will always be substantially equal in a relatively brief measuring period in equal circumstances. If the peaks are disregarded, it is necessary to use a much longer measuring time for obtaining a relatively constant average value. This would be a detrimental effect on the theft protection system since the alarm signal may then in case of theft be delivered at a relatively late instant.

Albeit the invention described above has been described in the foregoing with reference to the drawing figures, it should be established that the invention is not by any manner or means restricted to the embodiments shown in these drawing figures. The scope of the invention is also extended to any embodiments deviating from the embodiments shown in the drawing figures within the spirit and scope of the claims.

1. A theft protection system for use with a portable electrical appliance which is connectable to a voltage source via an adapter with transformer, in which in connected mode a charging current is carried between the voltage source and the portable electrical appliance, which theft protection system comprises an electronic alarm circuit to be inserted between the adapter and the voltage source, the alarm circuit comprising a processing unit with a current detector as well as an alarm means that delivers an alarm signal when the current detector detects a drop of the charging current below a predetermined limit value, characterized in that in a situation in which only the adapter with transformer is connected, the charging current forms a measure for the limit value.

2. A theft protection system as claimed in claim 1, characterized in that the alarm circuit comprises a calibration unit with which a basic charging current can be determined which is a measure for the limit value, which basic charging current occurs in the situation in which only the adapter with transformer is connected and the electrical appliance is not connected.

3. A method for detecting theft of an electrical appliance, the method comprising the steps of:
providing a theft protection system comprising an electronic alarm circuit to be inserted between the adapter and the voltage source, the alarm circuit comprising a processing unit with a current detector as well as an alarm means that delivers an alarm signal when the current detector detects a drop of the charging current below a predetermined limit value, characterized in that in a situation in which only the adapter with transformer is connected, the charging current forms a measure for the limit value, characterized in that the alarm circuit comprises a calibration unit with which a basic charging current can be determined which is a measure for the limit value, which basic charging current occurs in the situation in which only the adapter with transformer is connected and the electrical appliance is not connected; and
determining a basic charging current via the calibration unit, which basic charging current corresponds with the situation in which only the adapter with transformer is connected, the magnitude of the basic charging current being a measure for the limit value.

4. A method as claimed in claim 3, characterized in that the charging current is measured for at least 1 second in order to determine an average charging current.

5. A method as claimed in claim 4, characterized in that the voltage source is an AC voltage source and a zero crossing at the voltage source is detected and in that the charging current is measured from a fixed instant after the zero crossing.

6. A method as claimed in any one of the claims 3, characterized in that the alarm signal is delivered after the current detector in at least two consecutive measurements of the charging current detects a charging current drop below the limit value.

7. A theft protection system for use with a portable electrical appliance which is connectable to a voltage source via an adapter with a transformer, in which in connected mode a charging current is carried between the voltage source and the portable electrical appliance, the theft protection system comprising:
an electronic alarm circuit adapted to be inserted between the adapter and the voltage source, the electronic alarm circuit comprising a processing unit with a current detector as well as an alarm means that delivers an alarm signal when the current detector detects a drop of the charging current below a predetermined limit value, characterized in that in a situation in which only the adapter with transformer is connected, the charging current forms a measure for the limit value; and
further characterized in that the alarm circuit comprises a calibration unit with which a basic charging current can be determined which is a measure for the limit value, which basic charging current occurs in the situation in which only the adapter with transformer is connected and the electrical appliance is not connected.
